(19) United States
(12) Patent Application Publication
(10) Pub. No.: US 2013/0285993 A1
(43) Pub. Date: Oct. 31, 2013

(54) SYSTEM AND METHOD FOR ADJUSTING DISPLAY BRIGHTNESS BY USING VIDEO CAPTURING DEVICE

(71) Applicant: HON HAI PRECISION INDUSTRY CO., LTD., New Taipei (TW)

(72) Inventor: CHIUNG-SHENG WU, New Taipei (TW)

(73) Assignee: HON HAI PRECISION INDUSTRY CO., LTD., New Taipei (TW)

(21) Appl. No.: 13/753,532

(22) Filed: Jan. 30, 2013

(30) Foreign Application Priority Data
Apr. 25, 2012 (TW) 101114623

(51) Int. Cl. G09G 5/10

(52) U.S. Cl. CPC G09G 5/10
USPC 345/207

(57) ABSTRACT

A system includes a display, a video capturing device mounted on the display, and a brightness controller. The video capturing device captures N number of consecutive images during a time period. The brightness controller includes an object detecting unit for selecting one of the N number of images as a reference image and processing the other n−1 number of images relative to the reference image to detect any user of the display, a position determining unit for detecting a position of the user and determining any movement vector of the user of the N−1 images, a state determining unit for determining if the user is or is not using the display according to any movement vector of the user, and a brightness adjusting unit for adjusting a brightness of the display accordingly.

### BACKGROUND

1. Technical Field

The present disclosure relates to systems and methods for adjusting display brightness and, particularly, to a system and method for adjusting display brightness by using a video capturing device.

2. Description of the Related Art

When using a display of a computer or a television, a user may stop watching the display for some reason. The user needs to manually turn off the display and thus manually turn on the display again when he comes back, to save energy. This is inconvenient for the user.

Therefore, it is desirable to provide a system and method for adjusting display brightness thereof, which can overcome the above-mentioned problem.

### BRIEF DESCRIPTION OF THE DRAWINGS

FIG. 1 is a schematic view of a system for adjusting display brightness which has a video capturing device, according to an exemplary embodiment.

FIG. 2 is a functional block diagram of the system for adjusting display brightness of FIG. 1.

FIG. 3 is a schematic view showing the video capturing device of FIG. 1 capturing N number of consecutive images during a first time period, wherein N is a positive integer.

FIG. 4 is a schematic view showing that video capturing device of FIG. 1 capturing N number of consecutive images during a second time period.

FIG. 5 is a schematic view showing the video capturing device of FIG. 1 capturing N number of consecutive images during a third time period.

FIG. 6 is a schematic view showing the video capturing device of FIG. 1 capturing N number of consecutive images during a fourth time period.

FIG. 7 is a schematic view showing the video capturing device of FIG. 1 capturing N number of consecutive images during a fifth time period.

FIG. 8 is a flowchart of a method for adjusting display brightness, according to an exemplary embodiment.

### DETAILED DESCRIPTION OF THE EMBODIMENTS

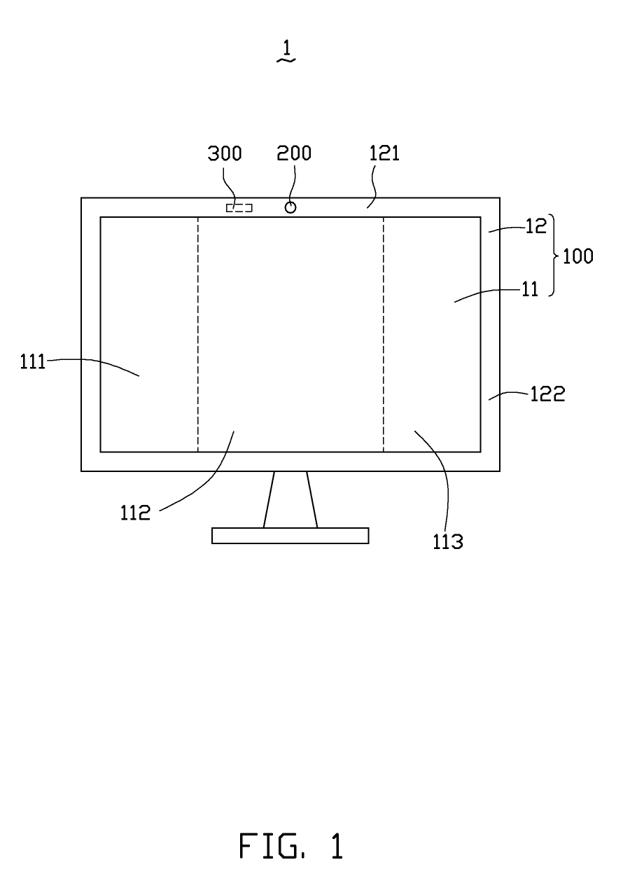

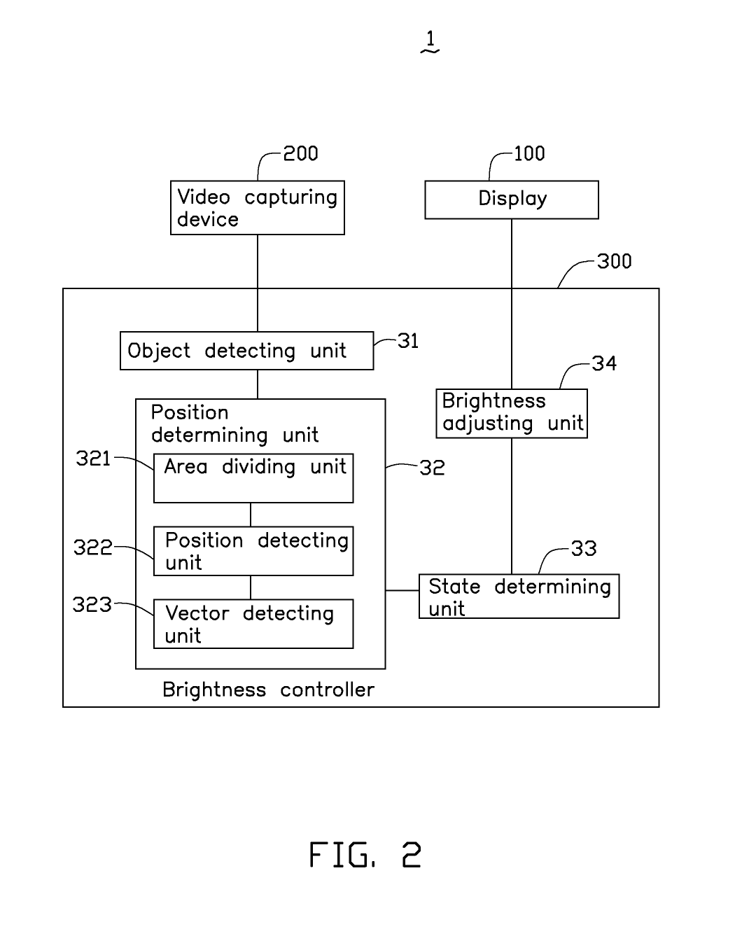

FIGS. 1, 2 show a system 1 for adjusting display brightness, according to an exemplary embodiment. The system 1 includes a display 100, a video capturing device 200, and a brightness controller 300.

The display 100 can be installed in a desktop computer, a television, or any other electronic device. The display 100 includes a screen 11 and a frame 12 for supporting and accommodating the screen 11. The screen 11 has virtual divisions into a left portion 111, a middle portion 112, and a right portion 113. The left portion 111 and the right portion 113 are at two sides of the middle portion 112 and opposite to each other. An area of the middle portion 112 is twice the area of each of the left portion 111 and the right portion 113. The frame 12 includes a pair of horizontal sides 121 and a pair of vertical sides 122 perpendicularly connecting with the horizontal sides 121.

The video capturing device 200 is mounted on the middle of one of the horizontal sides 121. In the embodiment, the video capturing device 200 is mounted on the middle of an upper horizontal side 121 and is configured for capturing video of an area in front of the display 100. The video capturing device 100 captures N number of consecutive images during a time period, wherein N is a positive integer and, in one example, N can be five. Each pixel of each image is represented by values of red, green, and blue.

The brightness controller 300 is mounted in the frame 12, for example, in the upper horizontal side 121 as shown in FIG. 1. The brightness controller 300 is electrically connected to the display 100 and the video capturing device 200.

The brightness controller 300 includes an object detecting unit 31, a position determining unit 32, a state determining unit 33, and a brightness adjusting unit 34. In the illustrated embodiment, the brightness controller 300 may be a processer, and all of the objects the detecting unit 31, the position determining unit 32, the state determining unit 33, and the brightness adjusting unit 34 may be computerized software instructions and can be executed by the processer.

The object detecting unit 31 detects a user in front of the display 100 from N number of images captured by the video capturing device 200 during the time period.

The object detecting unit 31 selects the first image of the N number of images as a reference image and processes the other N−1 number of images. In the embodiment, the object detecting unit 31 sequentially processes the other N−1 number of images as follows: differentiating the other N−1 number of images relative to the reference image, graying the differentiated N−1 number of images, binarizing the grayed N−1 number of images, blurring the binarized N−1 number of images, dilating the blurred N−1 number of images, detecting edges from the dilated N−1 number of images to extract the edges from each dilated image, rebinarizing the N−1 number of images after edges are detected (that is, the object detecting unit 31 binarizes the N−1 number of images for a second time) and detecting objects from the rebinarized N−1 number of images. In alternative embodiments, any one of the N number of images can be selected as the reference image.

Differentiating the N−1 number of images relative to the reference image means to obtain value differences between each image of the N−1 number of images and the reference image. The value differences are obtained by each pixel value of each image of the N−1 number of images deducting each pixel value of the reference image and then taking absolute values. Each pixel value of the N number of images is initially represented by the values of red, green, and blue.

Graying the differentiated N−1 number of images means to convert each differentiated image to a gray image, namely, each pixel value of each differentiated image is represented by a luminance value instead of being represented by the values of red, green, and blue.

Binarizing the grayed N−1 number of images means to compare the luminance value of each pixel of each grayed image to a first predetermined threshold. If the luminance value of each pixel of each grayed image is equal to or greater than the first predetermined threshold, the luminance value of each pixel of each grayed image is set to be 255, if the luminance value of each pixel of each grayed image is less than the first predetermined threshold value, the luminance value is set to be 0. The first predetermined threshold can be, and in one example is, 125.

Blurring the N−1 number of binarized images means defining a pixel whose luminance value is set at 255 of each binarized image as a center pixel, and then determining luminance values of eight other pixels surrounding the center pixel. If there are at least two pixels of the eight pixels which have luminance values set at 255, the luminance value of all the pixels in the eight pixels is set to be 255, otherwise the luminance value of all the eight pixels, and the center pixel also, are set to be 0.

Dilating the blurred N−1 number of images means that the luminance value of each pixel of each blurred image is multiplied by a matrix(M), the matrix(M) is shown as follows:

$$matrix ( M ) = [ \begin{matrix}0 & 1 & 0 \\ 1 & 1 & 1 \\ 0 & 1 & 0\end{matrix} ] .$$

Detecting edges from the dilated N−1 number of images means that the luminance value of each pixel of each dilated image is multiplied by a first matrix Sobel(V) and by a second matrix Sobel(H), then take a sum, and finally divided by two. Therefore, it can extract edges from each dilated image. The first matrix Sobel(V) and the second matrix Sobel(H) are shown as follows:

$$Sobel ( V ) = [ \begin{matrix}1 & 0 & 1 \\ 1 & 0 & 1 \\ 1 & 0 & 1\end{matrix} ]$$

$$Sobel ( H ) = [ \begin{matrix}1 & 1 & 1 \\ 0 & 0 & 0 \\ 1 & 1 & 1\end{matrix} ]$$

Rebinarizing the N−1 number of images after detecting edges means to compare the luminance value of each pixel of each image after detecting edges to a second predetermined threshold. If the luminance value of each pixel of each image after detecting edges is equal to or greater than the second predetermined threshold, the luminance value of each pixel of each image after detecting edges is set to be 255, otherwise the luminance value of each pixel of each image after detecting edges is set to be 0. The second predetermined threshold can be, and in one example is, 150.

Detecting objects from the rebinarized N−1 images means to extract objects from each rebinarized N−1 number images. Therefore a user (which is normally the only object in front of a video capture device) in front of the display 100 can be detected in the N−1 images through the object detecting unit 31. In alternative embodiments, objects can be detected by other technologies known to those skilled in the art.

The position determining unit 32 includes an area dividing unit 321, a position detecting unit 322, and a vector detecting unit 323. The area dividing unit 321 creates the virtual divisions of each image of the N−1 images processed by the object detecting unit 31 into a left area, a middle area, and a right area. The left area and the right area are at two sides of a middle area. An area of the middle area is twice of an area of each of the left area and the right area. The position detecting unit 322 detects which one of the left area, the middle area and the right area a position of the user is in for each image of the N−1 images. The vector detecting 323 determines a movement vector of the user according to detected results of the positions of the user in the N−1 images, through the position detecting unit 322.

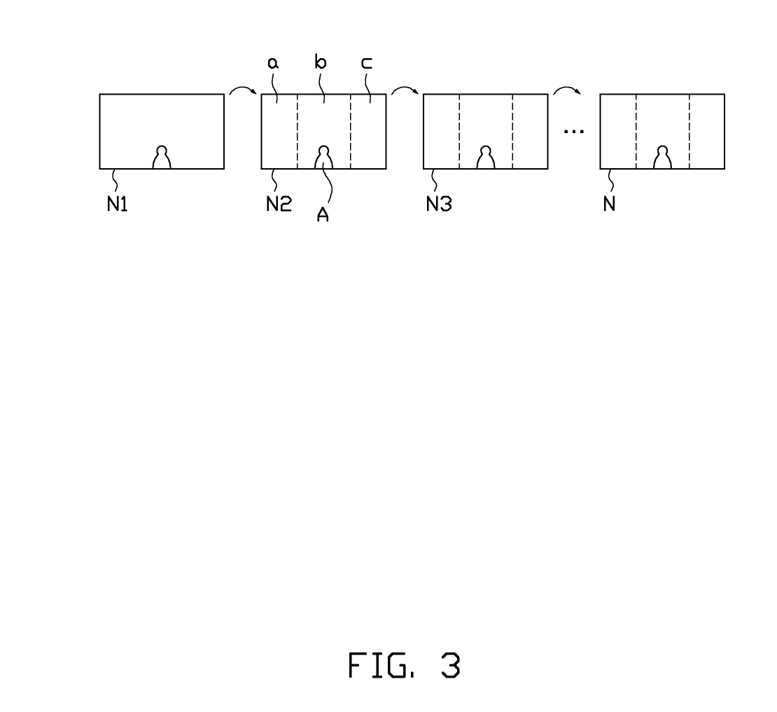

For example, in FIG. 3, the video capturing device 200 captures N number of images during a first time period. The object detecting unit 31 processes the second image N2 to the N-th image N relative to the first image N1 and detects a user “A” in each processed N−1 images (the second image N2 to the N-th image N). The area dividing unit 321 creates virtual divisions in each image of the N−1 image processed by the object detecting unit 31 into a left area “a”, a middle area “b”, and a right area “c”. The left area “a” and the right area “c” are at two sides of a middle area “b”. An area of the middle area “b” is twice of an area of each of the left area “a” and the right area “c”. The position detecting unit 322 detects that the user “A” is in the middle area “b” from the second image N2 to the N-th image N. The vector detecting unit 323 determines that the user “A” does not move out from the middle area “b” and labels a movement vector of the user “A” as V0.

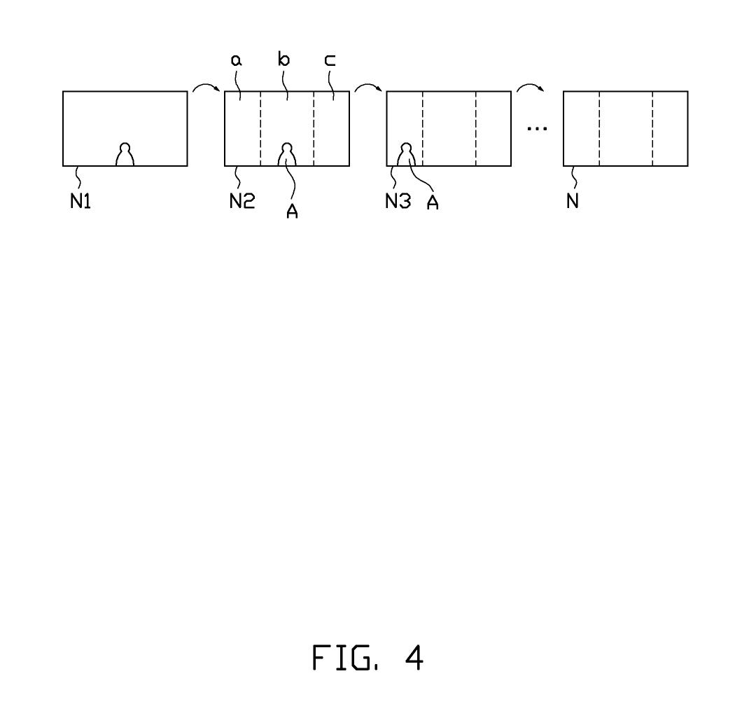

In FIG. 4, the video capturing device 200 captures N number of images during a second time period. The object detecting unit 31 processes the second image N2 to the N-th image N relative to the first image N1 and detects a user “A” in each processed N−1 images (the second image N2 to the N-th image N). The area dividing unit 321 creates virtual divisions in each image of the N−1 image processed by the object detecting unit 31 into a left area “a”, a middle area “b”, and a right area “c”. The position detecting unit 322 detects that the user “A” is in the middle area “b” in the second image N2, the user “A” is in the left area “a” in the third image N3, and the user “A” has disappeared in the N-th image N. The vector detecting unit 323 determines that the user “A” has moved from the middle area “b” to left area “a” and then from the left area “a” to out of the image N altogether. Then, the vector detecting unit 323 labels a movement vector of the user “A” as V1.

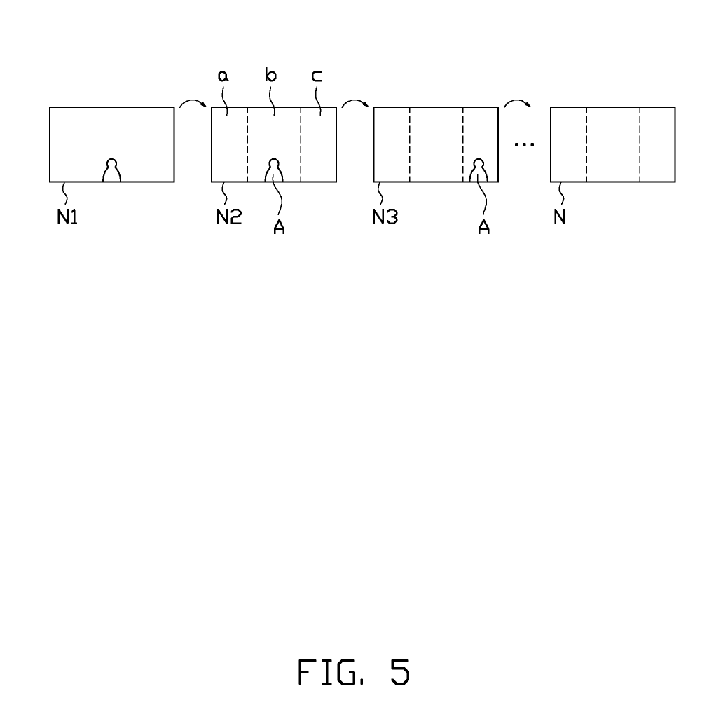

In FIG. 5, the video capturing device 200 captures N number of images during a third time period. The object detecting unit 31 processes the second image N2 to the N-th image N relative to the first image N1 and detects a user “A” in each processed N−1 images (the second image N2 to the N-th image N). The area dividing unit 321 creates virtual divisions in each image of the N−1 images processed by the object detecting unit 31 into a left area “a”, a middle area “b”, and a right area “c”. The position detecting unit 322 detects that the user “A” is in the middle area “b” in the second image N2, then the user “A” is in the right area “c” in the third image N3, and the user “A” has disappeared in the N-th image N. The vector detecting unit 323 determines that the user “A” has moved from the middle area “b” to the right area “c” and then from the right area “c” to out of the image N altogether. Then the vector detecting unit 323 labels a movement vector of the user “A” as V2.

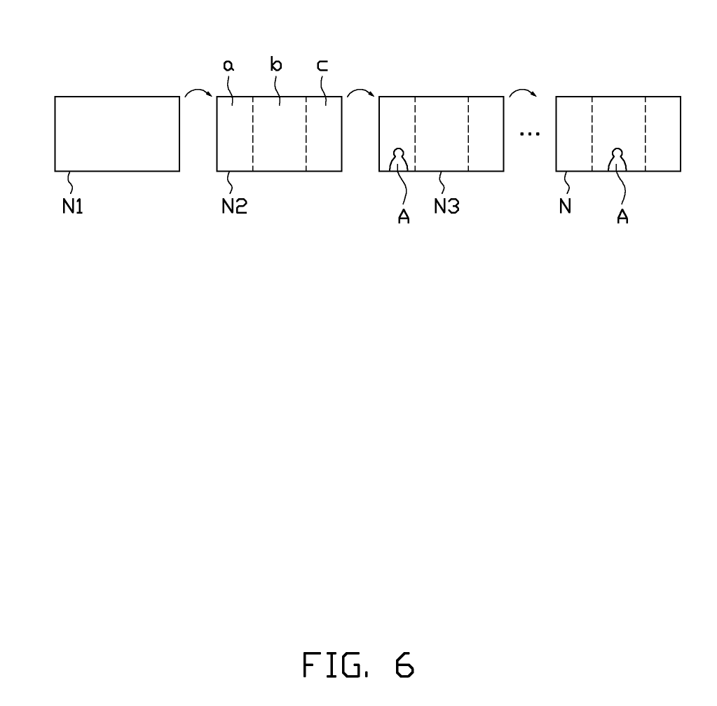

In FIG. 6, the video capturing device 200 captures N number of images during a fourth time period. The object detecting unit 31 processes the second image N2 to the N-th image N relative to the first image N1 and detects a user “A” in each processed N−1 images (the second image N2 to the N-th image N). The area dividing unit 321 creates virtual divisions in each image of the N−1 images processed by the object detecting unit 31 into a left area “a”, a middle area “b”, and a right area “c”. The position detecting unit 322 detects that the user “A” does not appear in the second image N2, then the user “A” is in the left area “a” in the third image N3, and the user “A” is finally in the middle area “b” in the N-th image N. The vector detecting unit 323 determines that the user “A” has moved from out of the second image N2 to the left area “a” and then from the left area “a” to the middle area “b”. Then the vector detecting unit 323 labels a movement vector of the user “A” as V3.

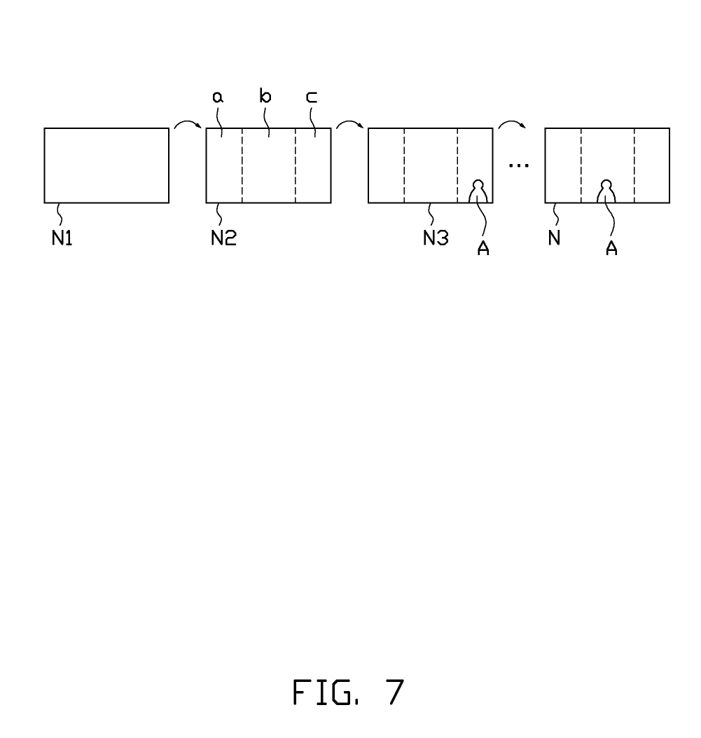

In FIG. 7, the video capturing device 200 captures N number of images during a fifth time period. The object detecting unit 31 processes the second image N2 to the N-th image N relative to the first image N1 and detects a user “A” in each processed N−1 images (the second image N2 to the N-th image N). The area dividing unit 321 creates virtual divisions in each image of the N−1 image processed by the object detecting unit 31 into a left area “a”, a middle area “b”, and a right area “c”. The position detecting unit 322 detects that the user “A” does not appear in the second image N2, the user “A” is in the right area “c” in the third image N3, and the user “A” is in the middle area “b” in the N-th image N. The vector detecting unit 323 determines that the user “A” has moved from out of the second image N2 to the right area “c” and then from the right area “c” to the middle area “b”. Then the vector detecting unit 323 labels a movement vector of the user “A” as V4.

The state determining unit 33 determines if the user “A” is using the display 100 according to the above-mentioned vectors of the user “A” labeled by the vector detecting unit 323. When the vector of the user “A” is V0, the state determining unit 33 determines that the user “A” is in front of and facing the middle portion 112 and is using the display 100.

When the movement vector of the user “A” is V1 or V2, the state determining unit 33 determines that the user “A” has moved from middle portion 112 to left portion 111 or to the right portion 113 in front of the display 100, and has then left the display 100. In these cases, the state determining unit 33 determines that the user “A” is not using the display 100.

When the movement vector of the user “A” is V3 or V4, the state determining unit 33 determines that the user “A” is not in front of the display 100 and then moves into left portion 111 or into the right portion 113 and then into middle portion 113 in front of the display 100. In these cases, the state determining unit 33 determines that the user “A” has come back to the display 100 and is again using the display 100.

The brightness adjusting unit 34 adjusts the brightness of the display 100 according to the determinations made by the state determining unit 33.

For example, in FIG. 3, the vector of the user “A” is V0 and the state determining unit 33 determines that the user “A” is using the display 100. The brightness adjusting unit 34 adjusts the brightness of the display 100 to an initial brightness L. The initial brightness L can be manually set by the user “A” and that brightness level stored by the brightness adjusting unit 34.

In FIGS. 4 and 5, the movement vector of the user “A” is V1 or V2 and the state determining unit 33 determines that the user “A” is not using the display 100. The brightness adjusting unit 34 adjusts the brightness of the display 100 to the initial brightness L when the user “A” is in the middle area “b” in the second images N2 of FIGS. 4 and 5, adjusts the brightness of the display 100 to a half of the initial brightness L when the user “A” is in the left area “a” or the right area “c” in the third images N3 of FIGS. 4 and 5, and turns off the display 100 when the user “A” has disappeared from the N-th images N of FIGS. 4 and 5.

In FIGS. 6 and 7, the movement vector of the user “A” is V3 or V4 and the state determining unit 33 determines that the user “A” has come back to the display 100 and is again using the display 100. From a turned-off state, the brightness adjusting unit 34 adjusts the brightness of the display 100 to a half of the initial brightness L when the user “A” is in the left area “a” or in the right area “c” in the third images N3 of FIGS. 4 and 5, and adjusts the brightness of the display 100 to the initial brightness L when the user “A” is in the middle area “b” in the N-th images N of FIGS. 6 and 7.

The brightness adjusting unit 34 can automatically adjust the brightness of the display 100, which is convenient for the user “A”.

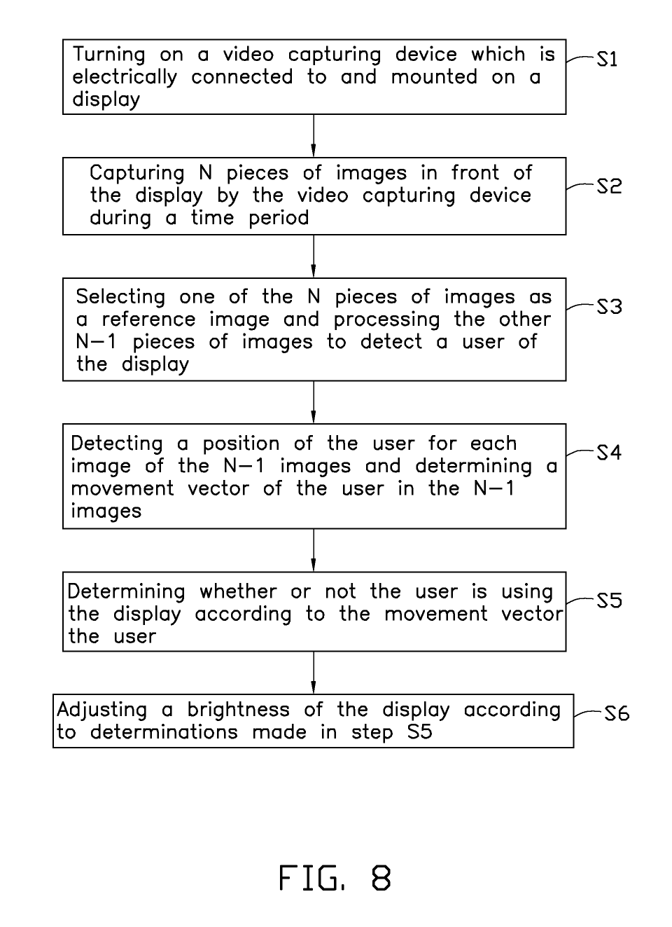

Referring to FIG. 8, an exemplary embodiment of a method for adjusting display brightness is shown. The method includes the following steps:

S1: turning on a video capturing device 200 mounted on a display 100. In this step, the display 100 is also turned on.

S2: capturing N number of images in front of the display 100 by the video capturing device 200 during a time period.

S3: selecting one of the N number of images as a reference image and processing the other N−1 number of images to detect a user of the display.

S4: detecting a position of the user for each image of the N−1 images and determining a movement vector of the user, of the N−1 images. In this step, further including the following steps: creating virtual divisions in each image of the N−1 images into a number of areas; detecting which area the position of the user is in for each image of the N−1 images; and determining a movement vector of the user according to the positions within the N−1 images.

S5: determining whether or not the user is using the display 100 according to the movement vector of the user;

S6: adjusting a brightness of the display 100 according to the determinations made in step 5.

While the disclosure has been described by way of example and in terms of preferred embodiments, it is to be understood that the disclosure is not limited thereto. On the contrary, it is intended to cover various modifications and similar arrangements, which would be apparent to those skilled in the art. Therefore, the scope of the appended claims should be accorded the broadest interpretation so as to encompass all such modifications and similar arrangements.

It is also to be understood that above description and any claims drawn to a method may include some indication in reference to certain steps. However, the indication used is only to be viewed for identification purposes and not as a suggestion as to an order for the steps.

What is claimed is:

1. A system for adjusting display brightness, comprising:
a display;
a video capturing device mounted on the display, the video capturing device being capable of capturing N number of consecutive images during a time period, wherein N represents a positive integer; and
a brightness controller electrically connected to the display and the video capturing device, the brightness controller comprising:
an object detecting unit for selecting one of the N number of images as a reference image and processing the other N−1 number of images relative to the reference image to detect a user of the display;
a position determining unit for detecting a position of the user for each image of the N−1 images and determining a movement vector of the user of the N−1 images;
a state determining unit for determining whether or not the user is using the display according to the movement vector of the user; and
a brightness adjusting unit for adjusting a brightness of the display according determinations made by the state determining unit.

2. The system as claim in claim 1, wherein the position determining unit comprises an area dividing unit, a position detecting unit, and a vector detecting unit; the area dividing unit creates virtual divisions in each image of the N−1 images processed by the object detecting unit into a left area, a middle area, and a right area; the left area and the right area are at two sides of a middle area; the position detecting unit detects which one of the right area, the middle area and the left area the position of the user is in for each image of the N−1 images; the vector detecting determines the movement vector of the user according to detected results of the positions of the user in the N−1 images through the position detecting unit.

3. The system as claim in claim 2, wherein when the position detecting unit detects that the user is in the middle area from the second image N2 to the N-th image N, the vector detecting unit labels the movement vector of the user as V0, the state determining unit determines that the user is using the display, and the brightness adjusting adjusts the brightness of the display to an initial brightness.

4. The system as claim in claim 2, wherein when the position detecting unit detects that the user moves from the middle area to the left area and then disappears from the second image N2 to the N-th image N, the vector detecting unit labels the movement vector of the user as V1, the state determining unit determines that the user does not use the display, the brightness adjusting unit adjusts the brightness of the display to an initial brightness when the user is in the middle area, to a half of the initial brightness when the user is in the left area, and turns off the display when the user disappears.

5. The system as claim in claim 2, wherein when the position detecting unit detects that the user moves from the middle area to the right area and then disappears from the second image N2 to the N-th image N, the vector detecting unit labels the movement vector of the user as V2, the state determining unit determines that the user does not use the display, the brightness adjusting unit adjusts the brightness of the display to an initial brightness when the user is in the middle area, to a half of the initial brightness when the user is in the left area, and turns off the display when the user disappears.

6. The system as claim in claim 2, wherein when the position detecting unit detects that the user does not appear, then the user is in the left area, and then the user is in the middle area from the second image N2 to the N-th image N, the vector detecting unit labels the movement vector of the user as V3, the state determining unit determines that the user comes back to the display and uses the display, the brightness adjusting unit turns off the display when the user does not appear, adjusts the brightness of the display to a half of an initial brightness when the user is in the left area, and adjusts the brightness of the display to the initial brightness when the user is in the middle area.

7. The system as claim in claim 2, wherein when the position detecting unit detects that the user does not appear, then the user is in the right area, and then the user is in the middle area from the second image N2 to the N-th image N, the vector detecting unit labels the movement vector of the user as V4, the state determining unit determines that the user comes back to the display and uses the display, the brightness adjusting unit turns off the display when the user does not appear, adjusts the brightness of the display to a half of an initial brightness when the user is in the right area, and adjusts the brightness of the display to the initial brightness when the user is in the middle area.

8. The system as claim in claim 2, wherein an area of the middle area is twice of an area of each of the left area and the right area.

9. The system as claim in claim 1, wherein the display comprises a screen and a frame supporting and accommodating the screen, the frame comprises a pair of horizontal sides and a pair of vertical sides perpendicular to the horizontal sides, and the video capturing device is mounted on the middle of one of the horizon sides.

10. A method for adjusting display brightness, comprising:
S1: turning on a video capturing device which is electrically connected to and mounted on a display;
S2: capturing N number of images in front of the display by the video capturing device during a time period;
S3: selecting one of the N number of images as a reference image and processing the other N−1 number of images to detect a user of the display;
S4: detecting a position of the user for each image of the N−1 images and determining a movement vector of the user in the N−1 images;
S5: determining whether or not the user is using the display according to the movement vector of the user;
S6: adjusting a brightness of the display according to determinations made in S5.

11. The method as claimed in claim 10, wherein the step S4 further comprises:
creating virtual divisions in each image of the N−1 images into a number of areas;
detecting which area the position of the user is in for each image of the N−1 images; and
determining the movement vector of the user according to the positions of the user within the N−1 images.
